(19) United States
(12) Patent Application Publication
(10) Pub. No.: US 2011/0222112 A1
(43) Pub. Date: Sep. 15, 2011

(54) INFORMATION PROCESSING SYSTEM, APPARATUS, AND METHOD

(76) Inventors: Yutaka YAGIURA, Yokohama city (JP); Michihiko Tsuda, Yokohama city (JP)

(21) Appl. No.: 13/009,426

(22) Filed: Jan. 19, 2011

(30) Foreign Application Priority Data
Mar. 11, 2010 (JP) 2010-054542

(51) Int. Cl. G06F 3/12

(52) U.S. Cl. 358/1.15

(57) ABSTRACT

An information processing system including an image forming apparatus, a relay unit, and a register unit that sends fax sending job information, including fax data generated from document data and setting information, to the relay unit. The relay unit stores the received fax sending data in a memory device, changes a part of fax setting information based on an instruction, sends the fax sending job information to the image forming apparatus in response to a request to acquire the fax sending data from the image forming apparatus, based on an instruction.

### CROSS-REFERENCE TO RELATED APPLICATIONS

The present application is based on Japanese Priority Patent Application No. 2010-054542, filed on Mar. 11, 2010, the entire contents of which are incorporated herein by reference.

### BACKGROUND OF THE INVENTION

1. Field of the Invention

Embodiments disclosed herein relate to an information processing apparatus, an information processing system, an information processing apparatus, and an information processing method.

2. Description of the Related Art

In recent years, there has been proposed an information processing apparatus that can immediately carryout an instruction to fax a document stored in the information processing apparatus to other facsimile machines. Therefore, such a system can decrease a burden to send faxes without printing the document.

On the other hand, safety in sending faxes is desired. Specifically, one requirement is that another person approve the sending of faxes so as to prevent an undesired transmission in a certain line of business.

However, if an information processing apparatus immediately carry outs an instruction to fax a document, the document is automatically sent in response to a fax sending job transmitted by the information processing apparatus.

However, it is a burden to obtain approval by another person at the information processing apparatus each time a fax is to be sent. There is no appropriate opportunity to approve the sending of the fax.
Patent Document 1: Japanese Patent No. 4150301

### SUMMARY OF THE INVENTION

Embodiments disclosed herein provide an information processing system, an information processing apparatus, and an information processing method in which one or more of the above-described disadvantages are eliminated.

A preferred embodiment of the present invention provides an information processing apparatus, an information processing method, and an information processing system with which a simple mechanism is implemented for managing fax data that is provided by collaboration of an image forming apparatus and an external application.

According to one embodiment, there is provided an information processing system comprising an image forming apparatus, a relay unit, a register unit configured to send fax sending job information, including fax data generated from document data and setting information, to the relay unit, wherein the relay unit is configured to store the received fax data in a memory device, to change a part of the setting information based on a first instruction, to send the fax sending job information to the image forming apparatus in response to a request to acquire the fax data from the image forming apparatus, based on a second instruction.

According to another embodiment, there is provided an information processing apparatus comprising a relay unit, a register unit configured to send fax sending job information, including fax data generated from document data and setting information to the relay unit, wherein the relay unit is configured to store the received fax data in a memory device, to change a part of the setting information based on a first instruction, to send the fax sending job information to an image forming apparatus in response to a request to acquire the fax data from the image forming apparatus, based on a second instruction.

According to another embodiment, there is provided an information processing method, the method comprising sending, by a register unit, fax sending job information, including fax data generated from document data and setting information to a relay unit, storing, by the relay unit, the received fax sending data in a memory device, changing a part of the setting information based on a first instruction, and sending the fax sending job information to a image forming apparatus in response to a request to acquire the fax data from the image forming apparatus, based on a second instruction.

Additional objects and advantages of the embodiments will be set forth in part in the description which follows, and in part will be apparent from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 illustrates a configuration of an information processing system according to the first embodiment;

FIG. 2 illustrates an example hardware configuration of an image forming apparatus of the embodiments disclosed herein;

FIG. 3 illustrates a hardware configuration example of a user terminal;

FIG. 4 illustrates an example relationship among widgets, a widget manager, and provider applications;

FIG. 5 illustrates example functional structures of the widget manager and the provider application;

FIG. 6 illustrates a relationship between each of a plurality of URIs according to the first embodiment;

FIG. 7 illustrates example contents of each of the URIs according to the first embodiment;

FIG. 8 is a sequence diagram for describing processing procedures performed when executing the widget manager and the fax widget according to the first embodiment;

FIG. 9 illustrates a structural example of a user information table;

FIG. 10 illustrates a structural example of the widget information component of the fax widget according to the first embodiment;

FIG. 11 is a sequence diagram for describing processing procedures performed when registering the fax sending job into the widget manager according to the first embodiment;

FIG. 12 illustrates a structural example of the fax setting information according to the first embodiment;

FIG. 13 is an example sequence diagram for describing processing procedures performed when carrying out a fax sending job;

FIG. 14 illustrates a configuration of an information processing system according to the second embodiment;

FIG. 15 is a sequence diagram for describing processing procedures performed when registering and approving a fax sending job for a widget manager according to the second embodiment;

FIG. 16 illustrates an example of a fax sending job information according to the second embodiment;

FIG. 17 illustrates an example of fax sending job information according to the third embodiment;

FIG. 18 illustrates a configuration of an information processing system according to the fourth embodiment;

FIG. 19 illustrates a relationship of URIs according to the fourth embodiment;

FIG. 20 illustrates example contents of the each URI according to the fourth embodiment;

FIG. 21 is a sequence diagram for describing processing procedures performed when executing the widget manager and the fax widget according to the fourth embodiment;

FIG. 22 is a sequence diagram for describing processing procedures performed when registering and approving a fax sending job for a widget manager according to the fourth embodiment; and

FIG. 23 illustrates an example of fax sending job information according to the fourth embodiment.

### DETAILED DESCRIPTION OF THE PREFERRED EMBODIMENTS

A description is given, with reference to the accompanying drawings, of the several embodiments disclosed herein.

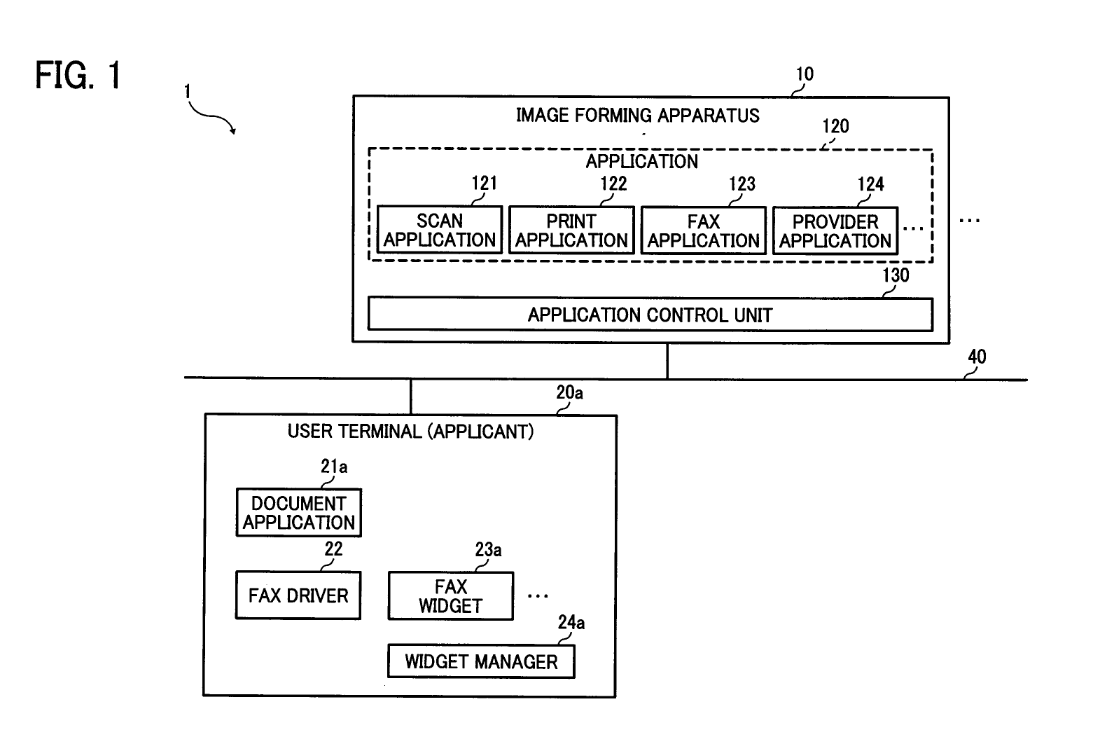

FIG. 1 illustrates a configuration of an information processing system according to the first embodiment. In the information processing system 1 of FIG. 1, one or more image forming apparatuses 10 and one or more user terminals 20 are connected so as to be mutually communicated via a wired or wireless network 40 such as a local area network (LAN).

The user terminals 20 are personally used by users. Software programs may be installed and executed on a processor in each user terminal 20. The user terminals 20 are not specifically limited as long as communication functions are provided. An example of the user terminals 20 is a desktop personal computer (PC), a notebook personal computer, a personal digital assistance (PDA), a mobile phone, etc. According to the present embodiment, the users using the user terminals 20 must obtain approval for the sending of a fax from the user's superior. Therefore, the user terminal 20a shown in FIG. 1 is indicated as “applicant”.

Referring to FIG. 1, the user terminal 20a includes one or more document applications 21a, a fax driver 22, a fax widget 23a, a widget manager 24a, etc.

The document application 21a includes an application for producing document data to be printed, such as word processor software and spreadsheet software. The fax driver 22 converts document data to fax data that can be sent by the image forming apparatus 10 in a format such as a Tagged Image File Format (TIFF) using fax control information, e.g., a fax number. The fax driver 22 is similar to a printer driver.

Specifically, the user can send faxes with the fax driver 22 by a procedure similar to printing documents edited in the document application. For example, a print dialog box of the document application 21a includes a logical printer corresponding to the fax driver 22 (logical fax). The fax driver 22 can display a properties screen page itself from the logical fax. The user can input fax setting information as fax control information in the properties screen page. After inputting the fax setting information, in response to an instruction to print in the print dialog box, the fax driver generates fax data corresponding to the document edited in the document application 21a. Generally, the fax data is sent to a printer port of the image forming apparatus.

In one embodiment, the fax driver 22 is set up to output generated fax data as a file having a predetermined file name without outputting the generated fax data to the printer port.

The fax widget 23a is one mode of an application program collectively referred to as a “widget” herein. In recent years, a convenient application program called a widget or a gadget has been created. The term “widget” is used to represent a characteristic program that is easily installed. This terminology is used without limiting any technical feature of the term “widget”. The widget disclosed herein remotely uses the function of the image forming apparatus 10 and provides a predetermined service, e.g., a sequence of processes such as a work flow, to the user. For example, the fax widget 23a carries out a process of sending fax input data using the image forming apparatus 10.

Although not illustrated, a scan widget or a print widget may be included in the user terminal. The scan widget causes the image forming apparatus 10 to scan a document, store the scanned image data into the user terminal 20a, or deliver the scanned image data. The print widget causes the image forming apparatus 10 to print input data.

The widget manager 24a provides a framework for the widget. The widget manager interfaces between the widget and the image forming apparatus 10. Each widget has an interface determined by the widget manager 24a and a process determined by the widget manager 24a. Stated differently, a program operated in coordination with the widget manager 24a is the widget. In this embodiment, the fax widget 23a sends a request to register the fax job to the widget manager 24a. The widget manager 24a stores information related to the fax job requested, e.g., fax setting information, fax data, etc.

The image forming apparatus 10 is a multifunction peripheral that can realize at least two of the functions of printing, scanning, copying, and fax transmission in one device. However, the image forming apparatus 10 may include at least a function of sending faxes.

Referring to FIG. 1, the image forming apparatus 10 has software including an application 120 and an application control unit 130. The application 120 is a program that carries out the job requested by the user. Further, a scan application 121, a print application 122, a fax application 123, and a provider application 124 are exemplified as the application 120. The scan application 121 carries out a scanning job. The print application 122 carries out print jobs. The fax application 123 carries out fax sending jobs and fax receiving jobs.

However, the printer port is defined in relation to the print application 122. Therefore, the print application 122 receives the fax data generated by the fax driver 22 in a manner similar to that with print data. The print application 122 sends received data to the fax application 123 if the print application 122 recognizes the received data as fax data in reference to a part of the received data, such as the header information. However, a fax port may be defined in relation to the fax application 123. In this case, fax data generated by the fax driver 22 may be sent to the fax port from the user terminal 20a.

The provider application 124 carries out coordination between the image forming apparatus 10 and the widget, strictly speaking, the widget manager 24a. For example, the provider application 124 acquires the fax sending job registered in the widget manager 24a and causes the image forming apparatus 10 to carry out the fax sending job.

The application control unit 130 interfaces between the applications 120. For example, the application control unit 130 switches the active application 120 in response to an operation instruction from the user. An operation screen of the active application 120 is displayed on an operation panel of the image forming apparatus 10. The active application 120 may be operated via the operation panel.

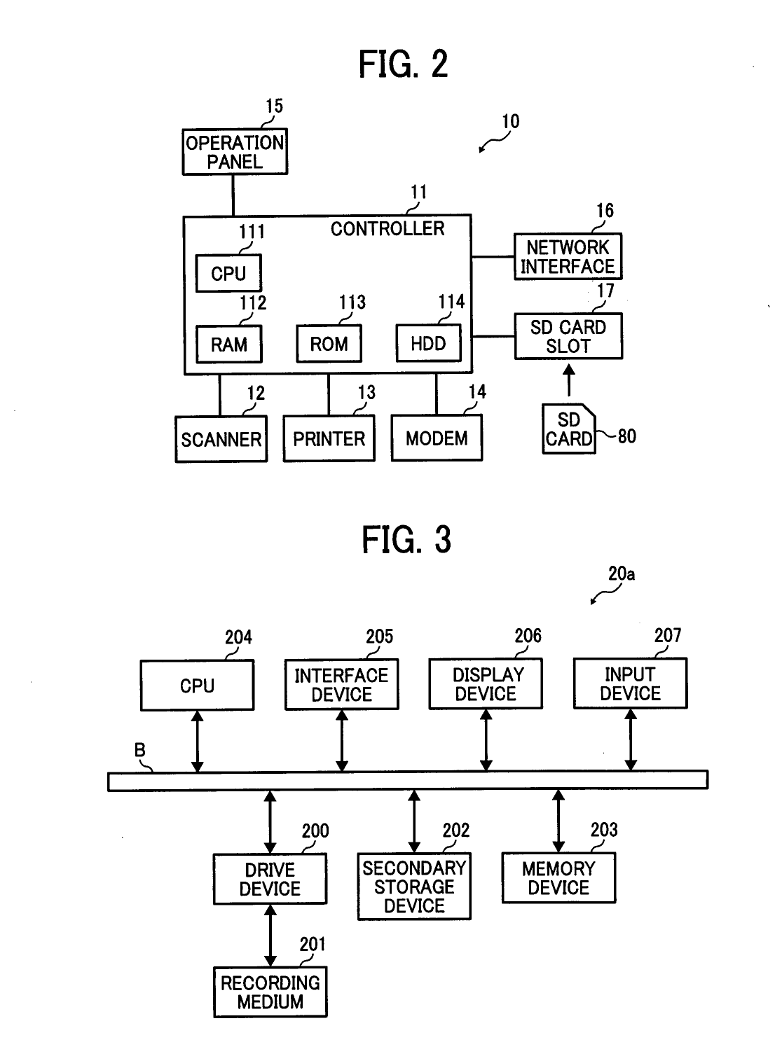

Next, hardware configurations of the various apparatuses and devices are described. FIG. 2 illustrates an example hardware configuration of the image forming apparatus. Referring to FIG. 2, the image forming apparatus 10 includes hardware such as a controller 11, a scanner 12, a printer 13, a modem 14, an operation panel 15, a network interface 16, and an SD card slot 17.

The controller 11 includes a CPU 111, a RAM 112, a ROM 113, an HDD 114, and so on. Various programs and data used by the various applications are stored in the ROM 113. The RAM 112 is used as a memory area for loading the programs, a work area for the loaded programs, etc. The CPU 111 executes various functions by processing the programs loaded into the RAM 112. The HDD 114 records programs, various data used by the programs, etc.

The scanner is hardware for reading image data from a manuscript. The printer 13 is hardware for printing the fax data on a print paper. The modem 14 is hardware for connecting the image forming apparatus 20 to a telecommunication line (not illustrated) and is used for sending and receiving the image data with fax communications. The operation panel 15 is hardware provided with an input unit for receiving an input from a user, such as a button and a display unit such as a liquid crystal panel. The network interface 16 is hardware for connecting the image forming apparatus 10 to a wired or wireless network such as a LAN. The SD card slot 17 is used to read a program recorded in the SD card 80. Said differently, not only the programs stored in the ROM 113, but also the programs stored in the SD card 80 may be loaded into the RAM 112 and executed by the image forming apparatus 10.

FIG. 3 illustrates a hardware configuration example of a user terminal. Referring to FIG. 3, the user apparatus terminal 20a includes a drive device 200, a secondary storage device 202, a memory device 203, a CPU 204, an interface device 205, a display unit 206, and an input unit 207, which are mutually connected by a bus B.

A program executing processes in the user terminal 20a is supplied by a recording medium 201, such as a CD-ROM. When the recording medium 201 with the program recorded on it is installed in the driving device 200, the program is installed in the secondary storage device 202 via the drive device 200. However, the program need not to be always installed from the recording medium 201, and may be downloaded from another computer via the network. The secondary storage device 202 stores necessary files, data, etc. in addition to the installed program.

The memory device 203 reads out the program from the secondary storage device 202 when the program is instructed to be executed and stores the program in the memory device 203. The CPU 204 realizes a function related to the user terminal 20a in conformity with the program stored in the memory device 203. The interface device 205 is used as an interface for connecting to the network. The display device 206 displays a Graphical User Interface (GUI), etc. generated by the program. The input device 207 is configured to include a keyboard, a mouse, etc., and is used to input various operational instructions.

The widget, the widget manager 24a, and the provider application 124 are now described in detail.

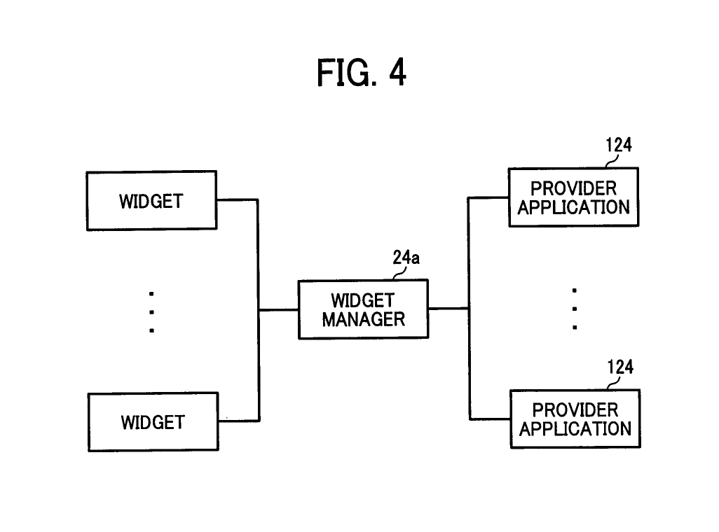

FIG. 4 illustrates an example relationship among widgets, a widget manager, and provider applications. Referring to FIG. 4, jobs (for example, fax jobs) may be registered in the widget manager 24a by plural widgets (for example, the fax widget 23a). The jobs registered in the widget manager 24a may be acquired by plural provider applications 124. The provider applications 124 correspond to the image forming apparatus 10 one-by-one. The jobs registered in the widget manager 24a may be executed by plural image forming apparatuses 10. When a print (fax) instruction is input into the user terminal 20a, it is not determined which image forming apparatus 10 actually executes the job (for example, sending faxes). The location of the image forming apparatus that actually sends the fax job can be freely determined.

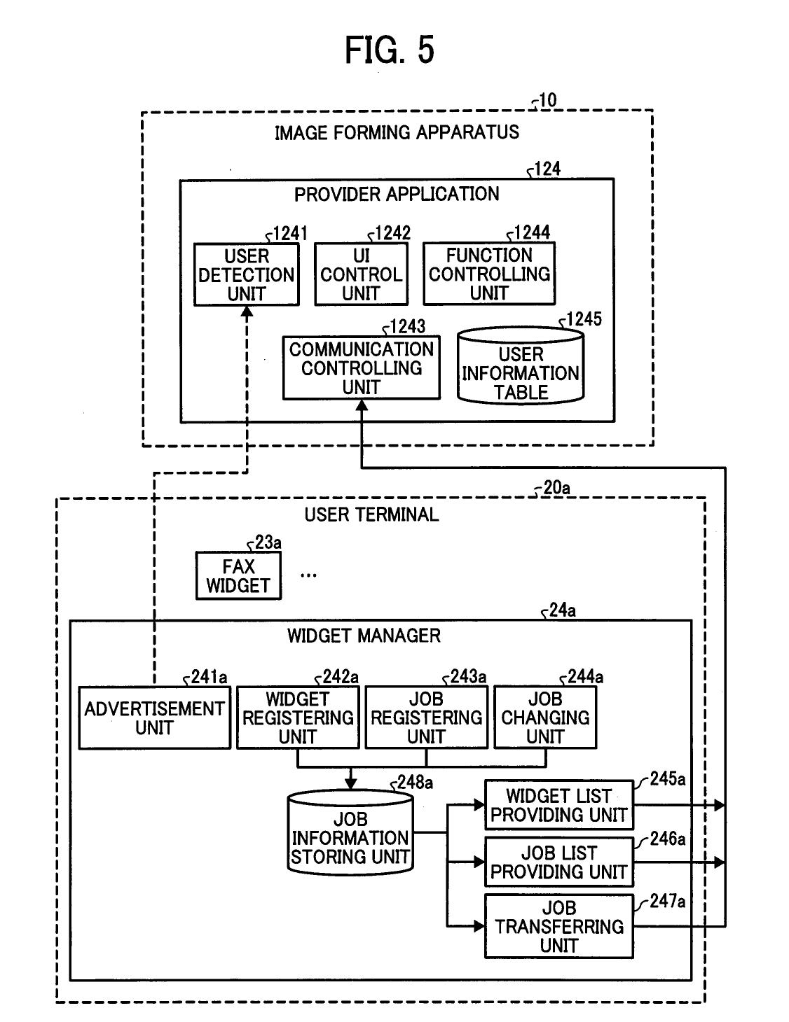

FIG. 5 illustrates example functional structures of the widget manager and the provider application.

Referring to FIG. 5, the widget manager 24a includes an advertisement unit 241a, a widget registering unit 242a, a job registering unit 243a, a job changing unit 244a, a widget list providing unit 245a, a job list providing unit 246a, a job transferring unit 247a, and a job information storing unit 248a.

The advertisement unit 241a issues a broadcast or a multicast for reporting the existence of the widget manager 24a onto the network 40 when the widget manager is executed. The advertisement may be sent to unspecified or many destinations by the broadcast, the multicast, etc. Therefore, the broadcast may be received by the provider application 124 of the image forming apparatuses 10 that wait for receipt of the advertisement. In this embodiment, the widget manager 24a exists one-by-one for each user terminal 20. Said differently the widget manager 24a is executed one-by-one for each user terminal 20a. The widget manager 24a corresponds to the users one-by-one. Therefore, the report of the existence of the widget manager 24a corresponds to a report of the existence of the user using the fax widget 23a. The advertisement includes an identifier (user ID) of a user who has logged in the user terminal 20a and executed the widget manager 24a, along with an identifier of the widget manager 24a. In this embodiment, the widget manager 24a is handled as a resource on the network and the identifier of the widget manager 24a may be a uniform resource identifier (URI). The URI is referred to as a “WIDGET MANAGER URI”.

The widget registering unit 242a receives a request to register widget information sent from the executed fax widget 23a and registers the widget information into the job information storing unit 248a. The widget information is attribute information of the fax widget 23a. For example, the widget information includes an identifier (widget ID) of the fax widget 23a, the name of the fax widget 23a, and so on. The widget manager 24a generates a uniform resource identifier (URI) as an identifier of the registered fax widget 23a. The URI (hereinafter, referred to as “widget URI”) is sent to the fax widget 23a as a response to the request to register the widget information.

The job registering unit 243a records or registers the fax sending job into the job information storing unit 248a in response to the request to register the fax sending job from the fax widget 23a registered in the job information storing unit 248a. The fax sending job information is information constituting the fax sending job. The fax sending job information includes the fax setting information and the fax data. The fax setting information is an attribute related to a fax sending job (for example, user ID or job name). The widget manager 24a generates the URI as the identifier of the registered fax sending job, and returns the URI (hereinafter, referred to as a fax sending job URI) to the fax widget 23a as a response to the registering request.

The job changing unit 244a changes the fax sending job information corresponding to the fax sending job URI designated in a changing request in response to the changing request to the already registered fax sending job. In this embodiment, the user may change fax setting information, the fax data, and so on corresponding to the fax sending job held by the widget manager 24a after a print (fax) instruction.

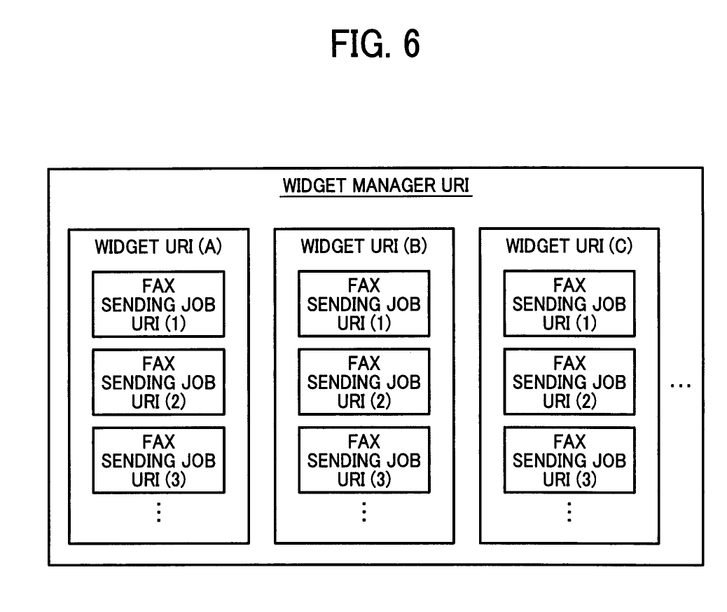

Next, a relationship among the above URIs is described. FIG. 6 illustrates a relationship between each of URIs according to the first embodiment. Referring to FIG. 6, a relationship among squares illustrates a hierarchy of URIs. When one of the squares encloses another of the squares, the enclosing square is in a higher hierarchy than that of the enclosed square. FIG. 6 illustrates the enclosure relationship or the hierarchy relationship among the resources or information identified by the URI.

As illustrated in FIG. 4, one or more fax widget(s) is (are) registered in the widget manager identified by one widget manager URI, and the widget URIs are given to corresponding fax widgets 23a. The widget URI indicates a position of a resource as a management space of information (widget information, fax sending job information, etc.) related to the fax widget 23a corresponding to the widget URI. The widget information, the fax sending job information, and so on of the fax widget 23a are registered in the management space indicated by the widget URI given to the fax widget 23a. The one fax widget 23a may register plural pieces of fax sending job information in the widget manager 24a. The fax sending job information registered in the widget manager 24a is managed as a resource on the network and fax sending job URIs are allocated to corresponding fax sending job information components.

Referring to FIG. 4, three fax widgets 23a are registered into the widget manager 24a, and the fax widgets 23a register the three fax sending job information components into the widget manager 24a. Therefore, the three widget URIs are generated under the widget manager URI, and three fax sending job URIs are generated under the widget manager URIs.

As described above, by managing the resources in association with the URIs, a component that operates the resources, such as the fax widget 23a or the provider application 124 via the network, may access various resources with a general-purpose WebAPI as an HTTP command.

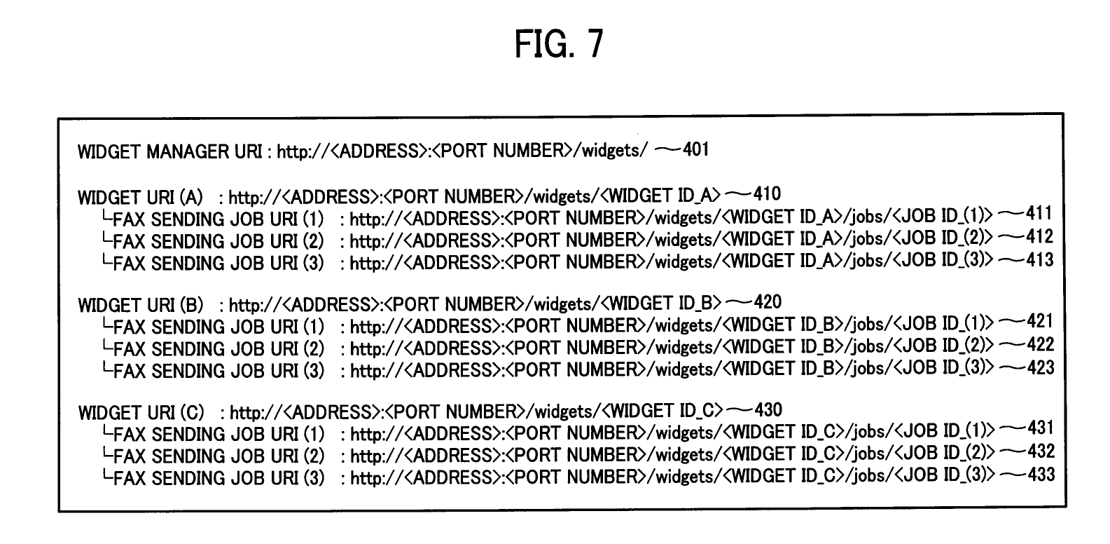

FIG. 7 illustrates example contents of each URI according to the first embodiment. FIG. 7 illustrates specific examples of the URIs illustrated in FIG. 6.

The description 401 is an example of the widget manager URI. In this embodiment, the path name of the widget manager URI is “widgets”. In FIG. 7, <ADDRESS> designates an IP address of the user terminal 20a, and <PORT NUMBER> designates a port number of the widget manager 24a.

Descriptions 410, 420, and 430 are specific examples of the widget URI of the different fax widgets 23a. The path name of the widget URI is “widgets/<WIDJET ID>”. Said differently, the path name is formed by adding the widget ID of the fax widget 23a to the path name of the widget manager URI.

The descriptions 411 to 413 correspond to three fax sending job information components registered by the fax widget 23a corresponding to the widget URI related to the description 410. The path name of the fax sending job URI is “widgets/<WIDGET ID>/jobs/<JOB ID>”. Said differently, the path name of the fax sending job URI is formed by adding the job ID of the fax sending job to the path name of the widget URI. The job ID is allocated or selected by the widget manager 24a when the fax sending job information is registered into the widget manager 24a. In a manner similar to this, the descriptions 421 to 423 correspond to three fax sending job information components registered by the fax widget 23a corresponding to the widget URI related to the description 420. The descriptions 431 to 433 correspond to three fax sending job information components registered by the fax widget 23a corresponding to the widget URI related to the description 430.

Referring back to FIG. 5, the widget list providing unit 245a returns a list of the fax widgets 23a registered in the job information storing unit 248a in response to a request by the provider application 124. The returned list information includes the widget URIs for each fax widget 23a.

The job list providing unit 246 returns the list of the fax sending jobs registered by the fax widget 23a related to the widget URI, which is designated by a request to acquire the list information of the fax sending jobs from the provider application 124 in response to the acquiring request. The list information to be returned includes fax sending job URIs for each fax sending job.

The job transferring unit 247a returns the fax sending job information of the fax sending job related to the fax sending job URI designated by the acquiring request in response to the acquiring request of the fax sending job from the provider application 124. The provider application 124 that has received the fax sending job causes the image forming apparatus 10 to carry out the fax sending job based on the fax sending job information.

Meanwhile, the provider application 124 includes a user detection unit 1241, a UI control unit 1242, a communication controlling unit 1243, a function controlling unit 1244, a user information table 1245, etc.

The user detection unit 1241 detects the existence of the user who can use the fax widget 23a, based on receipt of the advertisement issued by the widget manager 24a, and registers the user ID, etc. included in the advertisement into the user information table 1245. The UI control unit 1242 carries out display control of various screens for inputting operation instructions related to the provider application 124. The communication controlling unit 1243 sends a request to acquire the widget list information, a request to acquire the list of the fax sending job, a request to acquire the fax sending job, etc. to the widget manager 24a, and receives a response for the request. The function controlling unit 1244 carries out control of a function requested to the image forming apparatus 10 with the fax widget 23a that is subject to being used. The user information table 1245 having widget manager URIs of the widget manager 24a executed in the user terminals 20a, the user IDs of the user terminals 20, and so on is recorded in a memory device such as a HDD 114 of the image forming apparatus 10.

In this embodiment, communications between the fax widget 23a and the widget manager 24a, and between the widget manager 24a and the provider application 124, are carried out by the hypertext transfer protocol (HTTP). However, other communication protocols may be used.

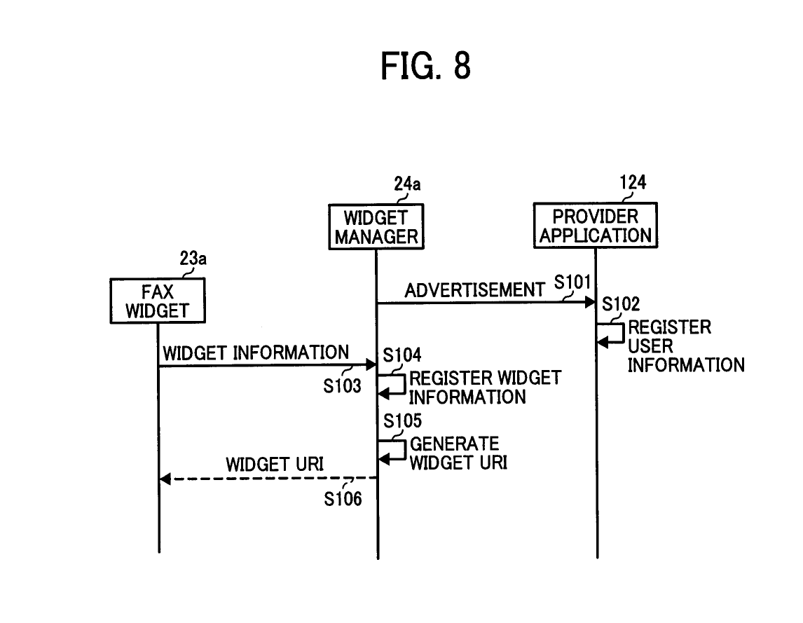

Hereinafter, the procedure of the information processing system 1 is described. FIG. 8 is a sequence diagram for describing processing procedures performed when executing the widget manager and the fax widget according to the first embodiment.

In step S101, when the widget manager 24a is executed upon a user's instruction or automatically executed at the user terminal 20a, the advertisement unit 241a of the widget manager 24a issues the advertisement of the user information including the user ID of the login user and the widget manager URI into the network 40.

Thereafter, in step S102, when the communication controlling unit 1243 of the provider application 124 receives the advertisement, the communication controlling unit 1243 registers the user information included in the advertisement into the user information table 1245.

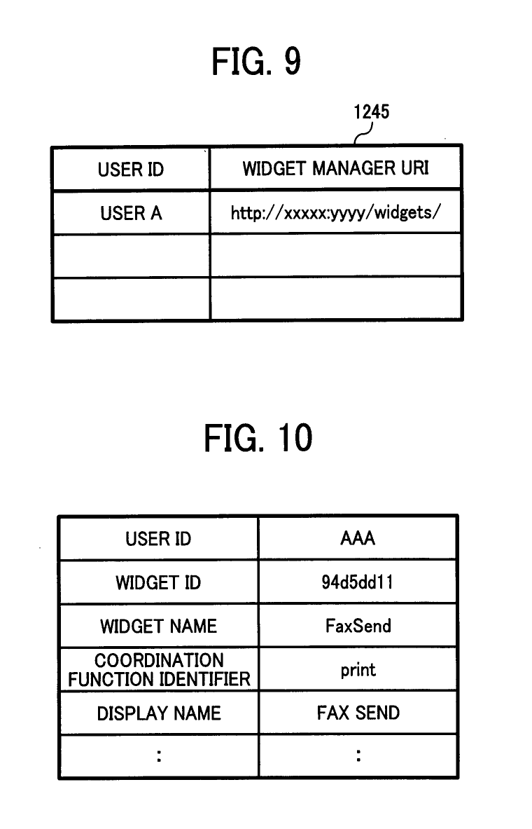

FIG. 9 illustrates a structural example of the user information table. Referring to FIG. 9, one record of the user information table 1245 corresponds to one user information item. Every record is formed by items such as a user ID and a widget manager URI. Values received in step S102 are directly recorded in the user information table.

Thereafter, in step S103, the fax widget 23a is executed in the user terminal 20a. The fax widget 23a reads the widget information from the setup file and sends a request to register the widget information to the widget manager URI. The widget manager URI is recorded in a memory region, such as a setup file of the fax widget 23a which the fax widget 23a can access.

FIG. 10 illustrates a structural example of the widget information of the fax widget according to the first embodiment. In this embodiment, the widget information of the fax widget 23a includes a widget ID, a widget name, a coordination function identifier, a display name, etc.

The widget ID is identifying information for uniquely identifying the fax widget 23a. The widget name is the name of the widget. The coordination function identifier is information for identifying a function that is used by the fax widget 23a and performed by the image forming apparatus 10, coordinating with the fax widget 23a. One example of the coordination function identifier is “printing”, “scanning”, etc. The print function is indicated by “print”, and the scan function is indicated by “scan”.

As described previously, the print application 122 receives data, and determines whether received data is fax data or not. In other words, an image forming apparatus 10 receives data without distinction between fax data and print data. Therefore, the fax widget 23a uses the print function of the image forming apparatus 10. The “print” is a coordination function identifier in the example illustrated in FIG. 10. The display name is a character string for displaying the fax widget 23a.

In step S104, widget registering unit 242a of the widget manager 24a registers the widget information into the job information storing unit 248a in response to a request to register the widget information.

Then, in step S105, the widget registering unit 242a generates the URI corresponding to the recorded widget information. The URI is the widget URI. The widget URI may be generated and allocated as “WIDGET MANAGER URI/<WIDGET ID>”. The widget information components and the widget URI are mutually associated and managed by the widget manager 24a.

Thereafter, in step S106, the widget registering unit 242a returns a response including the generated widget URI to the fax widget 23a. The widget ID of the fax widget is indicated by “9415d11” shown in FIG. 10. For example, the widget URI is allocated as “http://192.168.XXX.XXX/widgets/9415daa”. The fax widget 23a stores the received widget URI in the memory device 203.

After the above processes are completed, the fax sending job may be registered in the widget manager 24a.

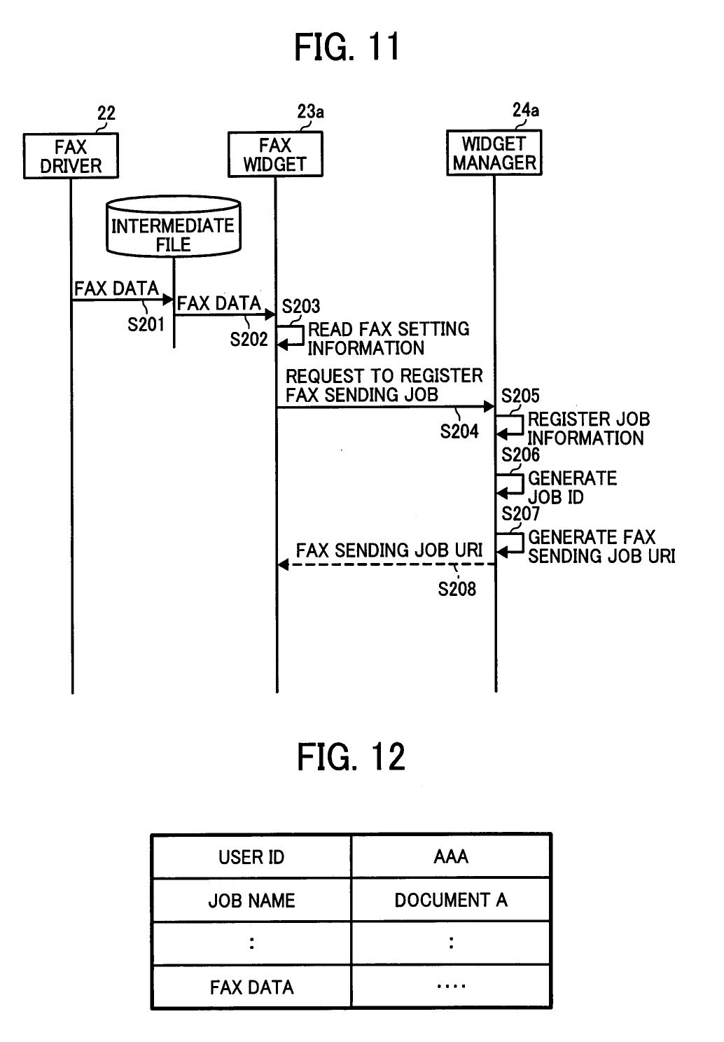

FIG. 11 is a sequence diagram for describing processing procedures performed when registering the fax sending job into the widget manager according to the first embodiment.

When a print (fax) instruction related to the fax driver is input into the user terminal 20a by the user who operates the document application 21a, the fax driver 22 generates fax data related to the document edited in the document application 21a. In step S201, when the logical fax corresponding to the fax widget 23a is designated as print, the fax driver 22 generates an intermediate file having a predetermined file name as an output destination for the logical fax.

Meanwhile, the fax widget 23a waits for the generation of the intermediate file having a predetermined file name after the fax widget 23a is executed. Specifically, the fax widget 23a performs polling to check whether the intermediate file exists. In step S202, when the fax widget 23a detects the generated intermediate file, the fax widget 23a reads fax data from the intermediate file. If plural fax widgets are executed in the user terminal, the logical faxes may be set up for each of the fax widgets 23a, and the file names of the intermediate files output by the logic faxes may be differentiated. The fax widgets 23a wait for the generation of the intermediate files that are output by the logic faxes corresponding to the fax widgets. Thus, a competition among the plural fax widgets 23a relative to the same intermediate file is avoidable. The plural fax widgets 23a are executed so that the fax number set up in the fax widgets 23a are differentiated and the fax widgets 23a to be used in response to a desired fax number are switched over. By selecting the logical fax corresponding to the fax widgets 23a, it is possible to select the fax widget 23a to be used. Therefore, the plural widgets corresponding to the logical fax should execute.

Thereafter, in step S203, the fax widget 23a reads the fax setting information from the setup file. Then, in step S204, the fax widget 23a sends a request to register the fax sending job including the fax setting information and fax data into the “WIDGET URI/jobs”. The destination of requesting to register the fax sending job is formed by adding “/jobs” to the path name of the widget URI. This naming rule may be commonly recognized between the widget manager 24a and the fax widgets 23a.

FIG. 12 illustrates a structural example of the fax setting information according to the first embodiment. The fax setting information shown in FIG. 12 includes a user ID, a job name, fax data, etc.

The user ID is identifying information for a user requesting a job. The job name is a name of the job. For example, a name of the document data to be sent by fax automatically becomes the job name. The fax data was described previously.

In step S205, in response to the request to register the fax sending job, the job registering unit 243a records the received fax sending job information into the job information storing unit 248a. Thereafter, in step S206, the job registering unit 243a generates the job ID corresponding to the fax sending job related to the registered fax sending job. Thereafter, in step S207, the job registering unit 243a adds a job ID to the URI designated as the destination of requesting to register the job information to thereby generate the fax sending job URI. The fax sending job information and the fax sending job URI are associated each other and managed by the widget manager 24a.

The widget manager 24a manages the fax sending job information and the fax data by distinguishing the fax sending job information and fax data in a separated form. Specifically, an independent URI is given to the fax data. Therefore, the fax data are handled as a single and independent resource. The fax data URI is formed by adding a predetermined symbol “/file/” to the path name of the fax sending job URI. This naming rule is recognized by both the fax widget 23a and the widget manager 24a. Adding the fax data URI to the fax data means that the fax widget 23a is independent from the fax setting information and can directly access the fax data.

Thereafter, in step S208, the widget registering unit 243a returns a response including the generated fax sending job URI to the fax widget 23a. For example, if “67ae2c2” is allocated as the job ID, the widget registering unit 243a returns http://192.168.XXX.XXX/widgets/9415d11/jobs/67ae2c2” as the fax sending job URI. The fax widget 23a stores the received fax sending job URI using the memory device 203.

The processes of FIG. 11 are carried out for every input of print (fax) instructions. As a result, as illustrated in FIG. 6, plural fax sending job information components for plural fax widgets 23a may be registered or accumulated in the widget manager 24a.

When document files to be sent as faxes (files storing the document data) are directly dragged and dropped onto an icon displayed by the fax widget 23a, the fax sending job information is registered into the widget manager 24a. Specifically, the fax widget 23a activates the document application 21a corresponding to the document file with a command line in which the file name of the dragged and dropped document file is designated as an argument, and a print process in which the logical fax corresponding to the fax widget 23a prints is carried out by the document application 21a. As a result, in a manner similar to step S201 of FIG. 11, the fax data for the document data are generated by the fax driver 22, and the fax data are output to an intermediate file having a predetermined file name and set up as the output destination of the logical fax. Thereafter, steps S202 to S208 are carried out. The document application 21a activated by the command line automatically ends. The document application 21a corresponding to the document file may be determined based on a table indicating a relationship between an extension of the document file and the document application 21a. The table may be maintained by the fax widget 23a or stored in the memory device used by the user terminals in common. When the document file dragged and dropped has a file form that can be directly sent as a fax, the processes on and after step S203 may be carried out without activating the document application 21a with the command line.

After registering the fax sending job, the user moves to a location of the image forming apparatus 10 to carry out the registered fax sending job. When plural image forming apparatuses 10 are connected to the network 40, the same advertisement is received by each of the image forming apparatuses 10, and the user ID and the widget manager URI are registered in the user information tables 1235 of the image forming apparatuses 10. Therefore, the user can carryout the fax sending jobs in any of the plural image forming apparatuses 10.

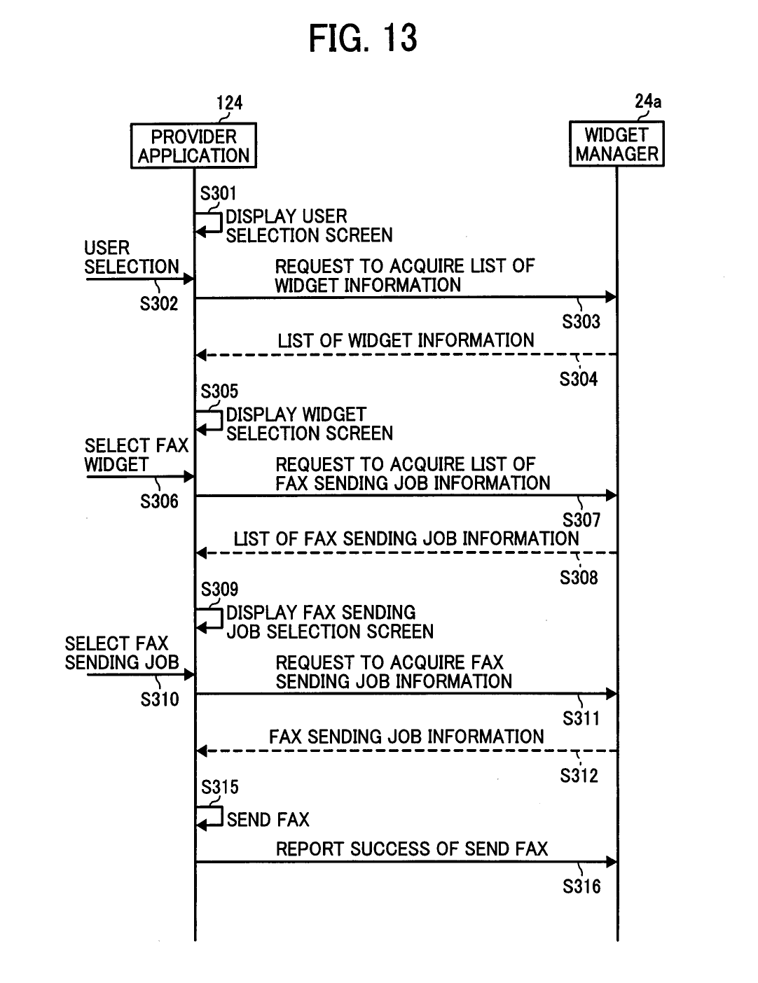

FIG. 13 is an example sequence diagram for describing processing procedures performed when carrying out the fax sending job.

When an instruction of using the provider application 124 via the operations panel 15 on the image forming apparatus 10 is input by a user, the application control unit 130 activates the provider application 124 to be the active application. The UI control unit 1242 of the provider application 124 detects that the provider application 124 is the active application 120. Then, in step S301, the UI control unit 1242 displays a user selection screen on the operation panel 15 based on the information registered in the user information table 1245. The user selection screen displays display components such as a button enabling a user to select each user ID registered in the user information table 1245.

Thereafter, in step S302, the user selects a button corresponding to the user ID on the user selection screen. The communication controlling unit 1243 acquires the widget manager URI associated with the user ID corresponding to the selected button from the user information table 1245. Thereafter, in step S303, the communication controlling unit 1243 sends a request to acquire a list of the widget information to the widget manager URI. The request to acquire the list of widget information is received by the widget list providing unit 245a of the widget manager 24a corresponding to the widget manager URI. In step S304, the widget list providing unit 245a returns the list of widget information, including all the widget information components and the widget URI associated with each of the widget information components to the provider application 124.

Thereafter, in step S305, the UI control unit 1242 of the provider application 124 records the received list of widget information components in the RAM 112, and displays a widget selection screen page including the list of the widgets usable by the user on the operation panel 15. Display components such as a button are displayed for each widget on the widget selection screen page. For example, display names of the widgets are displayed on the display components.

When a button corresponding to any of the fax widgets 23a is selected on the widget selection screen page in step S306, the communication controlling unit 1243 recognizes that the print (fax) is carried out based on the coordination function identifier “print” included in the widget information (hereinafter, referred to as “current widget information”) corresponding to the selected button. Therefore, in step S307, the communication controlling unit 1243 sends a request to acquire the list of the fax sending jobs to the widget URI associated with the current widget information component.

The request to acquire the list of the fax sending jobs to the widget URI is received by the job list providing unit 246 of the widget manager 24a related to the widget URI. In step S308, the job list providing unit 246 returns the list of the fax sending job URIs having the path name on and after “<the WIDGET URIs>/jobs” to the provider application 124.

Thereafter, in step S309, the UI control unit 1242 of the provider application 124 records the received list of the fax sending job URIs in the RAM 112, and displays a fax sending job selection screen page displaying a list of the registered fax sending jobs in the operation panel 15 based on the list. Display components such as a button are displayed for each fax sending job on the fax sending job selection screen.

When a button corresponding to any of the fax sending job URIs is selected on the widget selection screen page in step S310, the communication controlling unit 1243 sends the request to acquire the fax sending job information to the fax sending job URI corresponding to the selected button in step S311.

The request to acquire the fax sending job to the fax sending job URI is received by the job transferring unit 247a of the widget manager 24a related to the fax sending job URI. In step S312, the job transferring unit 247a acquires fax setting information and fax data from the job information storing unit 248a (the fax setting information is associated with the fax sending job URI and fax data is associated with the fax data URI of “<the FAX SENDING JOB URI/file/>”), and returns the fax sending job information, including the fax setting information and the fax data, to the provider application 124.

The communication controlling unit 1243 of the provider application 124 inputs the received fax sending job information to the function controlling unit 1244. In step S315, the function controlling unit 1244 causes the image forming apparatus 10 to carry out the fax sending job based on the fax setting information and the fax data.

Specifically, the function controlling unit 1244 sends the fax data to the printer port in relation to the print application 122 via an internal communication in the image forming apparatus 10. The print application 122 receives the fax data, and determines print data in reference to a part of the fax data, and inputs the fax data to the fax application 123. The fax application 123 sends image data, included the fax data, to a fax number included in the fax setting information with the modem 14.

In step S316, after the fax sending job normally finishes, the communication controlling unit 1243 sends a success report indicating that the fax sending job has been successfully carried out to the widget manager 24a.

Even though the fax sending job is successfully carried out by the widget manager 24a, the widget manager related to the fax sending job does not automatically delete the fax sending job information from the job information storing unit 248a. Therefore, the user can cause the image forming apparatus 10 or another image forming apparatus 10 to again carry out the same fax sending job. However, it is possible to automatically delete the fax sending job information only on a predetermined occasion. For example, the fax widget 23a may register information (hereinafter, referred to as an “automatic deletion flag”) indicating whether the fax sending job information is automatically deleted in the widget manager 24a. The widget manager 24a deletes the fax sending job information (the fax setting information and the fax data) from the job information storing unit 248a when the automatic deletion flag related to the fax sending job is in the on-state at a time of receiving the success report of the fax sending job from the provider application, and does not delete the fax sending job information when the automatic deletion flag in the off-state.

The value of the automatic deletion flag may be changed not only to the on or off-state, but also to “deletion after carrying out N times” or “deletion after a passage of N days”.

The fax widget 23a may determine the value of the deletion flag based on the content of the setup file. It is sufficient to register the value of the deletion flag into the setup file.

According to the first embodiment, the fax sending jobs instructed by users (applicants) are stored in the job information storing unit 248a in the widget manager 24a without sending automatically and immediately. Later, the stored fax sending jobs are sent with the image forming apparatus 10 in response to an operation at the image forming apparatus 10 by the users as shown in FIG. 13. Therefore, each user gives the user's superior an appropriate opportunity to approve the sending of a fax, when the user operates the image forming apparatus. In other words, the user's superior can observe the fax sending job at the image forming apparatus 10, and determine whether the fax sending job should be sent in reference to the fax sending job selection screen page in the operation panel 15.

According to the first embodiment, it is possible to reduce the approval time required for the user's superior because there is no need to scan original documents. Further the user's superior can approve plural stored fax sending jobs as a whole. Therefore, the burden to send faxes is reduced for users compared to when the superior must approve the fax at the applicant's user terminal 20a for each fax to be sent.

Hereinafter, the second embodiment is described. Common elements between the second embodiment and the first embodiment are not described again in detail.

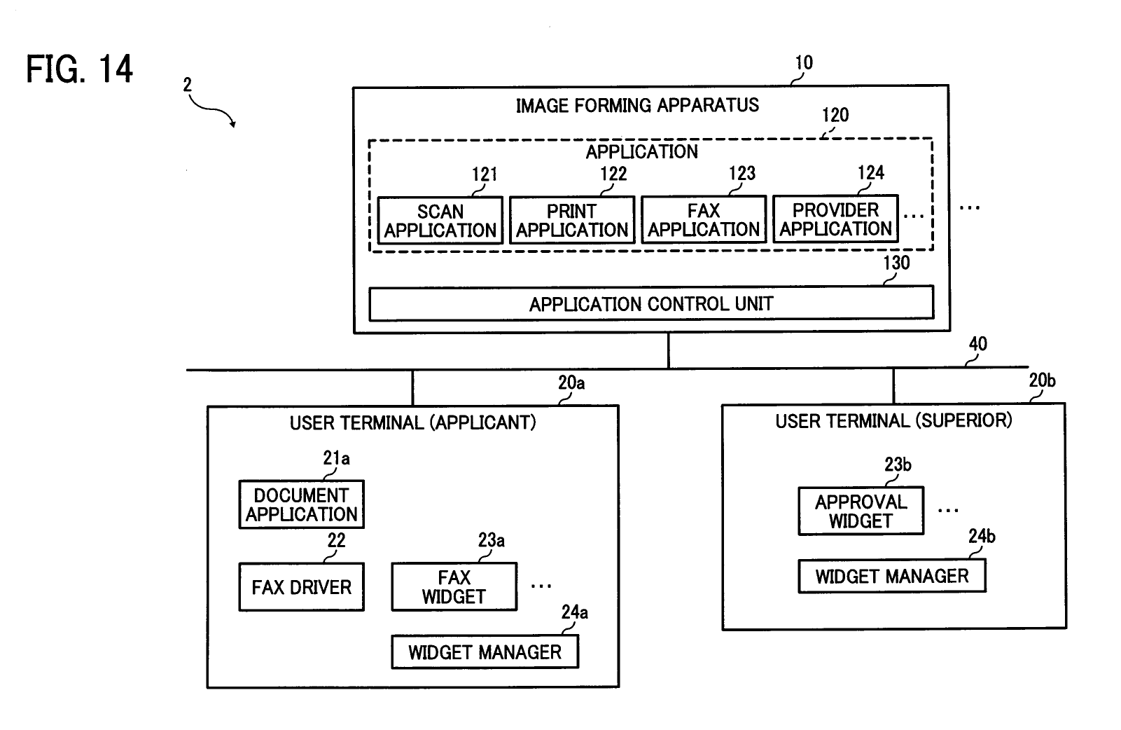

FIG. 14 illustrates a configuration of an information processing system according to the second embodiment. Common elements in FIG. 14 and FIG. 1 have common reference symbols, and the description of those common elements is not repeated here.

The information processing system 2 of FIG. 14 additionally includes a user terminal 20b. The user terminal 20b is one of the user terminals for the superior to approve (hereinafter, “superior terminal 20b”).

The superior terminal 20b includes a approval widget 23b and a widget manager 24b. The approval widget 23b is a widget for the superior to approve fax sending jobs of applicants. The widget manager 24b has substructures similar to those of the widget manager 24a shown in FIG. 8. The substructures of the widget manager 24b are distinguished from widget manager 24a by symbol suffixed ‘b’.

According to the second embodiment, processing procedures in executing the widget manager 24b and the approval widget are performed similar to the processing procedure shown in FIG. 8 with the widget manager 24b and the approval widget 23b, instead of with the widget manager 24a and the fax widget. Therefore, a user ID of a superior and a widget manager URI of the widget manager 24b are registered in the user information table 1245 of the provider application 124 in the image forming apparatus 10 when widget manager 24b executes. Widget information of the approval widget 23b is registered to the widget manager 24b when the approval widget executes. Next, the widget manager 24b generates a widget URI associated with the widget information. The widget URI is allocated as “<WIDGET MANAGER 21b URI>/<WIDGET ID of the approval widget>”.

The following description assumes that the widget manager 24b and the approval widget 23b are executed in the superior terminal 20b, while the widget manager 24a and the fax widget 23a are executed in the applicant terminal 20a.

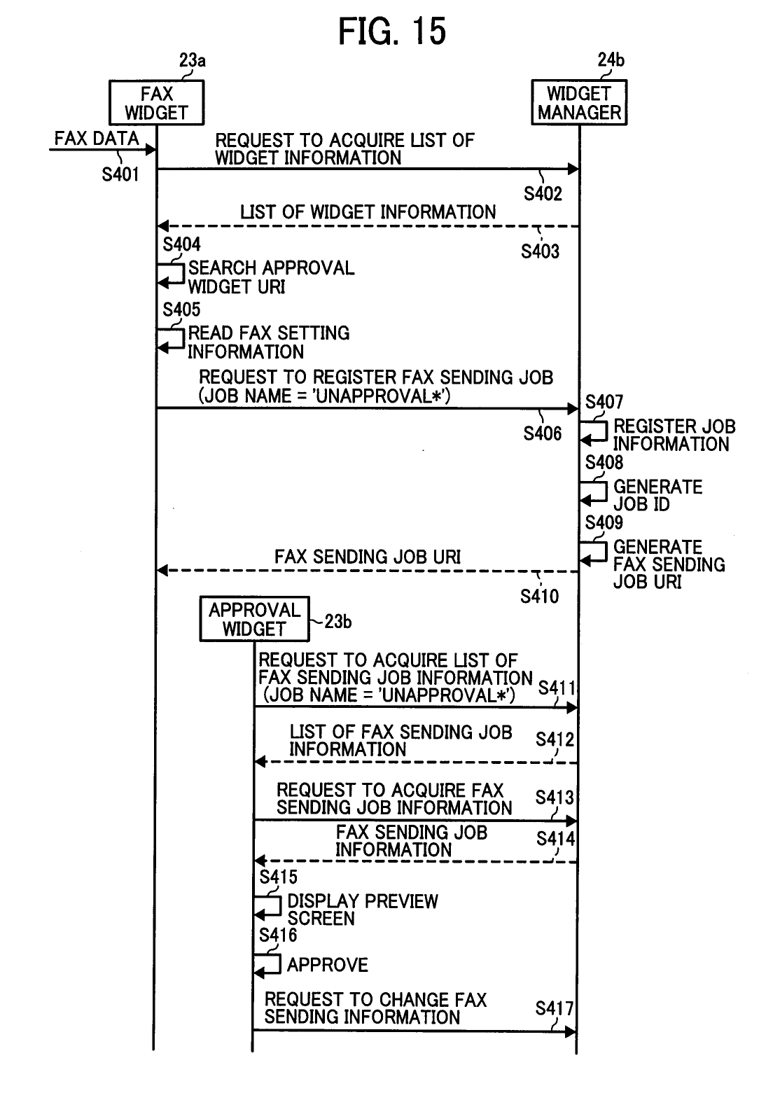

FIG. 15 is a sequence diagram for describing processing procedures performed when registering and approving a fax sending job for a widget manager according to the second embodiment.

A processing procedure at step S401 is similar to the process in steps S201-202 shown in FIG. 11. In other words, in step S401, when the fax widget 23a detects that the intermediate file has been generated, the fax widget 23a reads fax data from the intermediate file. In step S402, the fax widget 23a sends a request to acquire a list of the widget information to the widget manager URI of the widget manager 23b. In advance, the widget manager URI may be registered to the setup file of the fax widget 23a in the applicant terminal 20a.

The request to acquire the list of widget information is received by the widget list providing unit 245b of the widget manager 24b corresponding to the widget manager URI. In step S403, the widget list providing unit 245b returns a list of widget information including all the widget information, components and the widget URI associated with each of the widget information components in the job information storing unit 248b in the widget manager 24b, to the fax widget. The processing procedure at steps S402-S403 is similar to that of steps S303-S304 shown in FIG. 13. The list of widget information includes the widget URI related to the approval widget 23b, because the approval widget 23b is already executing.

Next, in step S404, the approval widget 23b determines whether the list of widget information includes the widget URI related to the approval widget. Specifically, widget URI related to the approval widget may be registered in the setup file of the fax widget 23a in advance. The fax widget 23a searches for a widget URI included in the widget ID as a path name in the list of widget information.

If the widget URI related to the approval widget is recognized, a processing procedure in steps S405-S410 is performed similar to the process in steps S203-208 shown in FIG. 11. However, the fax widget 23a adds the prefix ‘unapproved’ to a job name of the fax setting information, and sends the fax setting information.

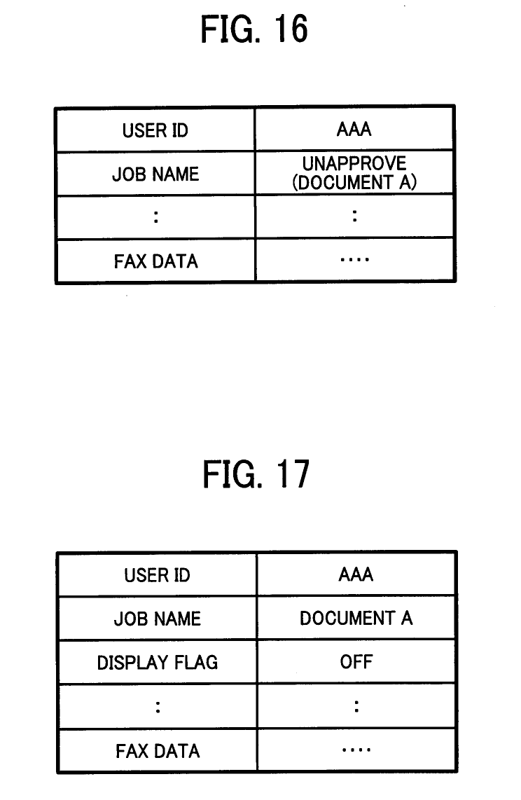

FIG. 16 illustrates an example of fax sending job information according to the second embodiment. FIG. 16 illustrates that an original job name in brackets to which the prefix ‘unapproved’ has been added.

The fax widget 23a sends the fax sending job information to “<WIDGET ID of the approval widget>/jobs/”. In other words, the fax sending job information is sent to the widget manager 23b in the superior terminal 20b instead of to the widget manager 23a in the applicant terminal 20a. Therefore, the processing procedure in steps S406-S410 is performed by the widget manager 24b. As a result, the widget manager 24b stores the fax sending job information in the job information storing unit 248b, and generates a job ID and a fax sending job URI of the fax sending job that corresponds to the fax sending job information components. The fax sending job information is stored in association with the widget URI of the approval widget 23b. In other words, the approval widget registers the fax sending job information as its own job.

Next in step S411, the approval widget 23b sends a request to acquire the list of the fax sending jobs to the widget URI associated with the widget information components of the approval widget 23b. The request is specified subject to job names having a prefix ‘unapproved’. For example, the request may be performed by polling at any time, in response to an instruction to operate the approval widget by the superior, or in response to a notice to have registered a fax sending job from the fax widget to the approval widget.

The request to acquire the fax sending job sent to the fax sending job URI is received by the job list providing unit 246b of the widget manager 24b related to the fax sending job URI. The job list providing unit 246a returns a list of the fax sending job URIs having the path name on and after “<the WIDGET URI>/jobs” corresponding to a job name having the prefix ‘unapproved’ of the fax sending job information component. Therefore, a list is returned that includes at least the fax sending job URI corresponding to the fax sending job information piece registered in step S406.

In steps S411-S412, all fax sending information components registered for the approval widget may be returned. In this case, the approval widget may extract fax sending job URIs corresponding to a job name having a prefix ‘unapproved’ of the fax sending job information piece.

Next, in step S413, the approval widget 23b sends the request to acquire the fax sending job information to the received fax sending job URI.

The request to acquire the fax sending job sent to the fax sending job URI is received by the job transferring unit 247b of the widget manager 24b related to the fax sending job URI. In step S414, the job transferring unit 247b acquires fax setting information and fax data from the job information storing unit 248b (the fax setting is associated with the fax sending job URI and the fax data is associated with the fax data URI of “<the FAX SENDING JOB URI/file/>”), and returns the fax sending job information, including the fax setting information and the fax data, to the approval widget 23b.

The processing procedure in steps S411-S414 is similar to the process in steps S307-308 and S311-S312 shown in FIG. 13.

Next, the approval widget displays a preview screen page to confirm received fax data in a display unit of the superior terminal 20b. The preview screen page may display fax numbers including fax data. The superior can determine whether the fax sending job should be approved with reference to the preview screen page. If the superior determines that the fax sending job should be approved, the superior pushes a button to approve, such as an OK button or an approve button. If the superior determines that the fax sending job should not be approved, the superior pushes a button not to approve, such as a CANCEL button or a REJECT button.

In response to pushing the button to approve, the approval widget 23b sends a request to change the job name of the fax sending information to the fax sending job URI. Specifically, the request includes the job name with the prefix ‘unapproved’ to be changed to the job name with the prefix ‘APPROVED’. In response to the request, the job changing unit 244 changes the job name of the fax sending job information.

On the other hand, if the button not to approve is pushed, the approval widget 23b does not send the request to change the job name. In this case, the approval widget 23b may send a request to delete the fax sending information to the fax sending job URI. In response to the request, the job changing unit 244 deletes the fax sending job information corresponding to the fax sending job URI.

The processing procedure in step S413 and after is performed for each of the fax sending job URIs received in step S412.

After approving the fax sending job, the superior moves to a location of the image forming apparatus 10 to carry out the registered fax sending job. The superior can carry out the fax sending jobs in any of the plural image forming apparatuses 10 in the same way as in the first embodiment.

A processing procedure operated at the image forming apparatus 10 is similar to the process shown in FIG. 13. However, the superior, instead of the applicant, carries out the fax sending jobs at the image forming apparatus according to the second embodiment. It is impossible for the applicant to carry out the fax sending jobs because the fax sending jobs are registered with the widget manager 23b in the superior terminal 20b. Therefore, the widget manager 24a shown in FIG. 13 is replaced by the widget manager 24b in the superior terminal 20b.

The widget selection screen page shown in step S305 displays a button corresponding to the approval widget 23b, because the widget manager 23b registered the widget information of the approval widget 23b. If the button corresponding to the approval widget 23b is pushed, the fax sending job selection screen page is displayed. The job name prefix ‘unapproved’ is displayed for the fax sending job that is unapproved, and the job name prefixed with ‘approved’ is displayed for the fax sending job approved in the fax sending job selection screen page. Therefore, the superior may select a job displayed with the job name having the prefix ‘approved’ to carry out the fax sending jobs.

According to the second embodiment, it is possible to confirm the document data to be sent as a fax by the superior. Further, in this embodiment, the superior carries out the fax sending jobs at the image forming apparatus so that the superior can approve the faxes with certainty.

In another example, the preview screen page may not be displayed. The job name may not have the prefixes ‘unapproved’ or ‘approved’ added. In this case, the superiors may determine whether the fax sending job is approved in reference to the fax sending job selection screen page.

Hereinafter, the third embodiment is described. In the third embodiment, the fax sending job selection screen page displays a fax sending job approved to send faxes by a superior.

A processing procedure in the third embodiment is similar to the process of the second embodiment. However, as shown in FIG. 15, the fax widget 23a sends the fax sending job information shown in FIG. 17. Elements in common in the second embodiment and the third embodiment will not be described again.

FIG. 17 illustrates an example of fax sending job information according to the third embodiment. In FIG. 17, a display flag is included in the fax sending job information. The display flag is information used to determine whether a fax sending job should be displayed in the fax sending job selection screen page. The display flag is set to an initial value indicating the off-state. The initial value is a value when the widget manager 24a registers a fax sending job from the fax widget 23a.

In the third embodiment, the job name is not changed. Specifically, the fax widget 23a does not add a prefix ‘approved’ or ‘unapproved’ to a job name.

Further, in this embodiment, the approval widget sends a request to change the display flag to the on-state to the fax sending job URI. In response to the request, the job changing unit 244b of the widget manager 24b changes the display flag of the fax sending job information piece correspond to the fax sending job URI. In other words, if a superior approves a fax sending job, the display flag is changed to the on-state.

Afterwards, the superior operates one of the image forming apparatuses 10 and the processing procedure shown FIG. 13 is performed.

When the processing procedure shown FIG. 13 is performed in the third embodiment, the widget manager 24b returns the fax sending job URI corresponding to a fax sending job information component whose display flag is ‘ON’. Therefore, only buttons corresponding to the fax sending job approved by the superior are displayed in the fax sending job selection screen page in step S309. Thus, it is possible to prevent an unapproved fax sending job from accidentally being carried out.

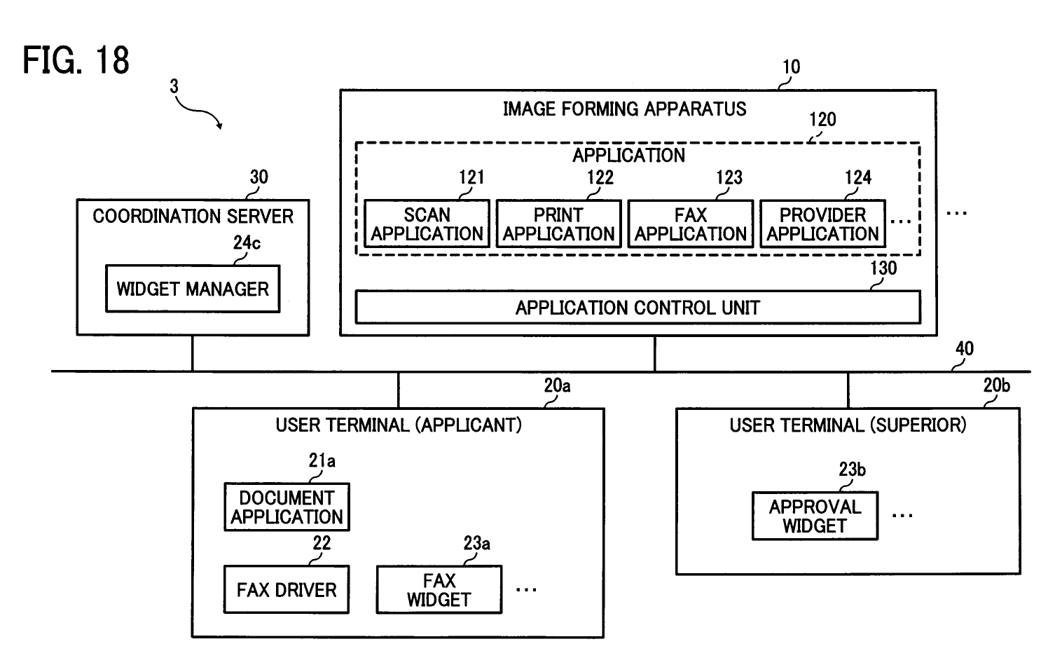

Hereinafter, the fourth embodiment is described. FIG. 18 illustrates a configuration of an information processing system according to the fourth embodiment. Common substructures in FIG. 18 and FIG. 14 have common reference symbols, and are not described again. The information processing system 3 of FIG. 18 additionally includes a coordination server 30. The coordination server 30 includes a widget manager 24c. The widget manager 24c includes similar substructures to those of the widget manager 24a shown in FIG. 5. The substructures of the widget manager 24c include the reference symbol ‘c’ to distinguish them from widget managers 24a and 24b.

The widget manager 24c is shared by each of the user terminals 20. Therefore, each of the user terminals 20 do not include a widget manager. The widget manager 24c uses HTTP (HyperText Transfer Protocol) as a communication protocol to communicate between widgets and the widget manager 24c. Even though the widget manager 24c is installed in an apparatus differing from the user terminal 20 installed widget, it possible to communicate between widgets and the widget manager 24c without any modification. However, setup files in each user terminal 20 are registered as a URI corresponding to the widget manager 24c in the coordination server 30.

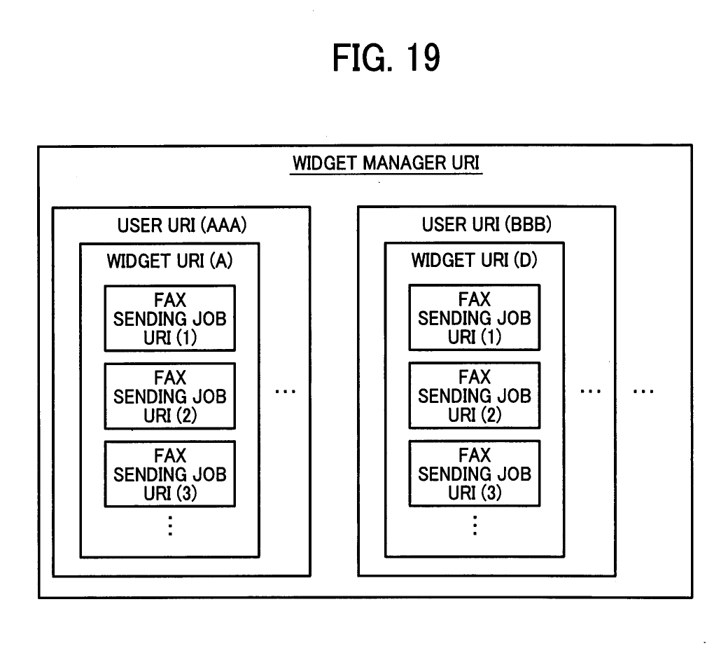

The widget manager 24c manages each user for the widget information components and the job information. Therefore, the widget manager 24c manages the information in the job information storing unit 248 based on the relationship of URIs shown in FIG. 19.

FIG. 19 illustrates a relationship of URIs according to the fourth embodiment. A user URI structure ranks between the widget manager URI and the widget URI. Specifically, the URI is formed by adding the user ID to the path name of predetermined symbol “/widget/”.

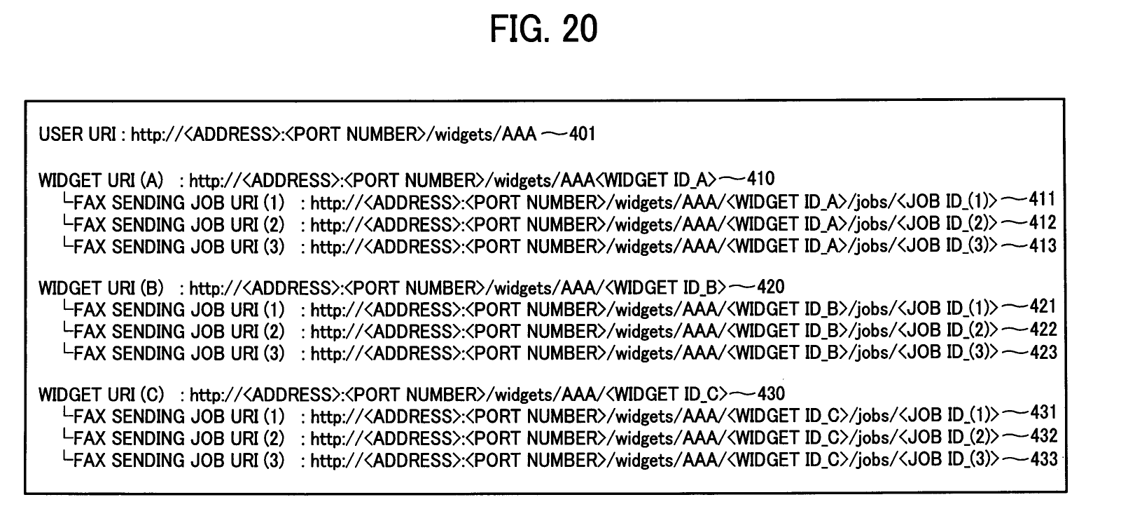

FIG. 20 illustrates example contents of each URI according to the fourth embodiment. Common URIs in FIG. 20 and in FIG. 7 have common reference symbols and their description is not repeated.

A URI shown in FIG. 20 corresponds to a user having a user ID ‘AAA’. Therefore, the widget manager URI of a description 401 adds the suffix ‘AAA’ to the path name. Each widget URI and each user URI adds ‘AAA’ between ‘widget’ and widget ID.

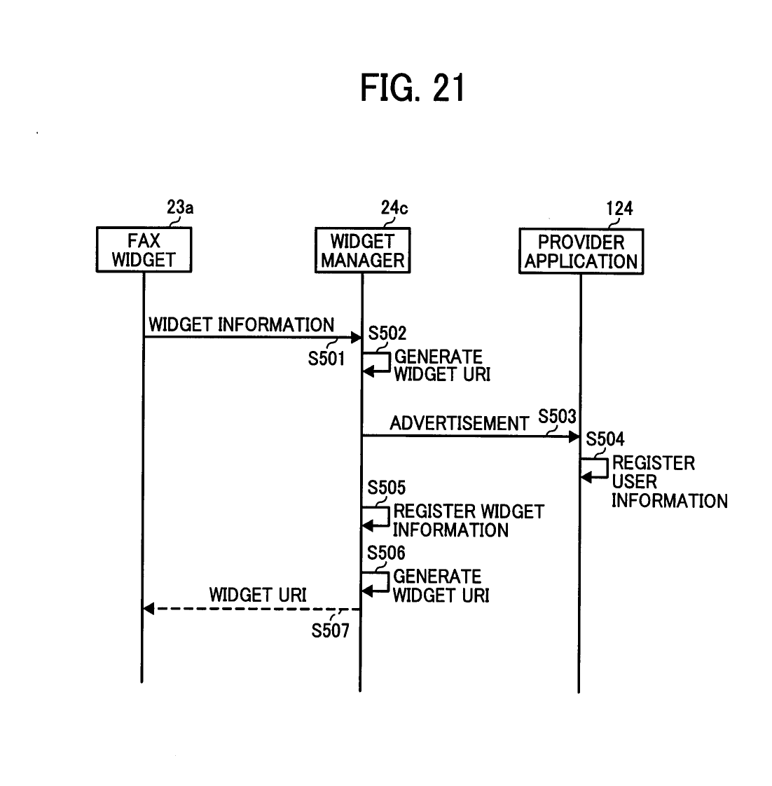

Next, a description is given of a process executed according to the information processing system 3. FIG. 21 is a sequence diagram for describing processing procedures performed when executing the widget manager and the fax widget according to a fourth embodiment.

In step S501, when the fax widget 23a is executed in the applicant terminal 20a, the fax widget 23a reads the widget information from the setup file and sends a request to register the widget information to the widget manager URI corresponding to the widget manager 24c. In step S502, in response to receiving the request, an advertisement unit 241c in the widget manager 24c generates a user URI based on the user ID of the widget information. Next, in step S503, the advertisement unit 241c sends an advertisement of the user information including the user ID and the user URI into the network 40. Therefore, the user URI is associated with the user ID to store the user table 1245. In other words, the provider application 124 manages the user URI instead of widget manager URI.

In step S505, the widget registering unit 242c in the widget manager 24c stores the widget information received in step S501 to the job information storing unit 248c. Next, in step S506, the widget registering unit 242c generates a widget URI related to the stored widget information.

Specifically, the widget URI is allocated as “WIDGET MANAGER URI/<USER ID><WIDGET ID>”. Then, in step S507, the widget registering unit 242c returns a response including the generated widget URI.

According to the fourth embodiment, the advertisement is issued in response to receiving the widget information (step S501). Therefore, the widget manager 24c may issue plural advertisements. However, if the URI has already been generated (i.e., a widget information component corresponding to a widget for a same user has been registered in the job information storing unit 248c), the advertisement unit 241c in the widget manager 24c will not issue an advertisement. Thus, the advertisement is issued by each user.

Therefore, an image forming apparatus receives a similar number of advertisements in the first three embodiments. In the fourth embodiment, the widget manager 24c exists one-by-one for each user terminal 20. Thus, the advertisement is issued by each user.

When the approval widget 23b is executed in the superior terminal 20b, a similar process shown in FIG. 21 is performed.

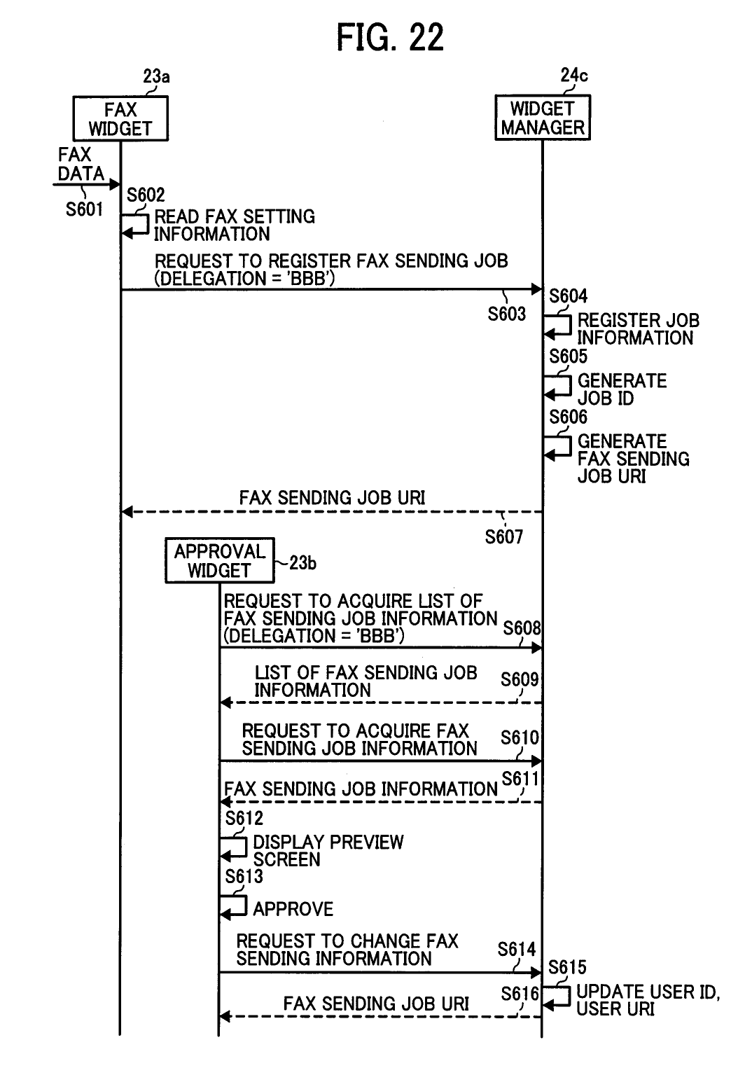

FIG. 22 is a sequence diagram for describing processing procedures performed when registering and approving a fax sending job for a widget manager according to the fourth embodiment.

A processing procedure in step S601 is similar to the process of step S401 shown in FIG. 15. When the fax widget 23a detects the generated intermediate file, the fax widget 23a reads fax data from the intermediate file.

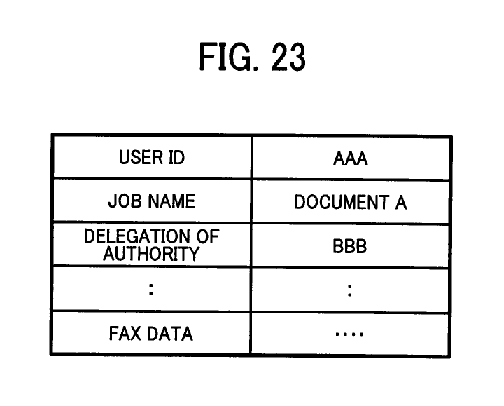

A processing procedure in steps S602-S607 is mostly similar to the process of steps S405-S410 in FIG. 15. In step S603, the fax widget 23a sends the fax sending job information shown in FIG. 23.

FIG. 23 illustrates an example of fax sending job information according to the fourth embodiment. As shown in FIG. 23, a delegation of authority field is included in the fax sending job information. The delegation of authority field is a user ID to change the user ID of the fax sending job information in the certain user ID-state. In the fourth embodiment, the delegation of authority field becomes a user ID of the superior (BBB). To change the user ID means that the authority of the fax sending job corresponding to the fax sending job information is delegated, as will hereinafter be described in detail.

A request to register the fax sending job information is sent to “USER URI/jobs/. Thus, the fax sending job information is managed by each user.

The approval widget 23b sends a request to acquire the list of the fax sending jobs to the widget URI in step S608, similar to step S411 shown in FIG. 15. The request is specified subject to the delegation of authority becoming a login user in the superior terminal 20b ‘BBB’.

The request to acquire the fax sending job sent to the fax sending job URI is received by the job list providing unit 246c of the widget manager 24c related to the widget manager URI. The job list providing unit 246a extracts the fax sending job information including the specified delegation of authority ‘BBB’ under the widget manager URI, and returns a list of fax sending job URIs related to the extracted fax sending job information. If plural applicants register fax sending jobs, the list of fax sending job URIs will include the fax sending jobs registered by the plural applicants.

A processing procedure in steps S601-S613 is a similar to the process of steps S413-413 shown in FIG. 15.

In step S614, the approval widget 23b sends a request to change the user ID of the fax sending job information to the fax sending job URI related to the approved fax sending job. Specifically, the request includes changing the user ID of the fax sending job information piece to ‘BBB’.

In response to the request, the job changing unit 244c of the widget manager 24c changes the user ID of the fax sending job information, if the user ID of the request indicates the delegation of authority. On the other hand, if the user ID of the request does not indicate the delegation of authority, the job changing unit 244c of the widget manager 24c does not change the user ID of the fax sending job information. A user who is not specified by the applicant registering the fax sending job should not send the fax sending job.

Incidentally, the fax sending job URI related to the fax sending job information piece also is changed when changing a user ID. Specifically, the user ID included in the fax sending job information changes the user ID of the request. Further, the widget ID included the fax sending job URI changes the widget ID of the approval widget 23b. In other words, the fax sending job is managed as a job registered by the approval widget 23b of user ‘BBB’. For example, in step S614, the widget ID of the approval widget may include the request to change the user ID. The widget manager 24c manages the changed fax sending job URI related to the fax sending job information.

Next, the job changing unit returns the changed fax sending job URI to the approval widget 23b.

According to the fourth embodiment, the widget manager 24c manages the fax sending job information corresponding to the fax sending job approved by the superior as the superior's fax sending job information.

Later, the superior operates one of the image forming apparatuses and performs a process mostly similar to that shown in FIG. 13, using a user URI instead of a widget manager URI. For example, in step S303, the communication controlling unit 1243 sends a request to the user URI related to the corresponding user ID button selected in the user selection screen page.

However, a widget selection screen page displayed in step S305 displays a button corresponding to the approval widget because the widget manager manages the widget information of the approval widget 23b for the superior. In response to pushing the button corresponding to the approval widget, the fax sending job selection screen page is displayed in step S309. The fax sending job selection screen page displays a list of fax sending jobs for the superior. In other words, the fax sending job information components approved by the superior are displayed.

It is possible to obtain a similar advantage in the second embodiment and third embodiments.

According to the embodiments discussed herein, operability of the accumulated fax sending jobs is improved.

The present application is not limited to the specific embodiments described herein, and variations and modifications may be made without departing from the scope of the embodiments described herein.

What is claimed is:

1. An information processing system, comprising:
an image forming apparatus;
a relay unit; and
a register unit configured to send fax sending job information, including fax data generated from document data and setting information, to the relay unit, wherein
the relay unit is configured to store the received fax data in a memory device, to change a part of the setting information based on a first instruction, to send the fax sending job information to the image forming apparatus in response to a request to acquire the fax data from the image forming apparatus, based on a second instruction.

2. The information processing system according to claim 1,
wherein the relay unit is configured to change the part of the fax setting information that determines whether the fax sending job information is displayed as a list in the image forming apparatus.

3. The information processing system according to claim 2, wherein
the relay unit is configured to send the fax sending job information changed by the relay unit to the image forming apparatus.

4. The information processing system according to claim 1,
wherein the relay unit is configured to change the part of setting information, which is a field having a value of ‘approve’ or ‘unapprove’.

5. The information processing system according to claim 1, wherein
the setting information includes a user identifier;
the relay unit is installed in a first apparatus having a first user identifier different from a second user identifier corresponding to a second apparatus in which the register unit is installed; and
the relay unit is configured to change the user identifier of the fax sending job information to the first user identifier corresponding to the first apparatus.

6. The information processing system according to claim 1, wherein
the setting information includes a user identifier; and
the register unit is configured to set the user identifier to a second user identifier to a second apparatus in which the register unit is installed.

7. The information processing system according to claim 6, wherein
the relay unit is installed in a first apparatus different from the second apparatus; and
the relay unit is configured to change the user identifier of the fax sending job information to a first user identifier corresponding to the first apparatus.

8. The information processing system according to claim 6, further comprising:
an approve unit configured to approve sending of the fax sending job information,
wherein the approve unit is installed in an apparatus different from the second apparatus; and
the relay unit is configured to change the user identifier of the fax sending job information to a third user identifier corresponding to the apparatus in which the approve unit is installed, in response to a third instruction.

9. An information processing apparatus comprising:
a relay unit; and
a register unit configured to send fax sending job information, including fax data generated from document data and setting information, to the relay unit, wherein
the relay unit is configured to store the received fax data in a memory device, to change a part of the setting information based on a first instruction, to send the fax sending job information to an image forming apparatus in response to a request to acquire the fax data from the image forming apparatus, based on a second instruction.

10. A method of information processing, comprising:
sending, by a register unit, fax sending job information, including fax data generated from document data and setting information, to a relay unit;
storing, by the relay unit, the received fax sending data in a memory device;
changing a part of the setting information based on a first instruction; and
sending the fax sending job information to an image forming apparatus in response to a request to acquire the fax data from the image forming apparatus, based on a second instruction.
